(19) United States
(12) Patent Application Publication
(10) Pub. No.: US 2008/0011803 A1
(43) Pub. Date: Jan. 17, 2008

(54) PILL SPLITTER WITH PROTECTED BLADE AND MODIFIED HINGE

(75) Inventors: Aidan Petrie, Jamestown, RI (US); Daniel Nelsen, Providence, RI (US)

Correspondence Address: BARLOW, JOSEPHS & HOLMES, LTD., 101 DYER STREET, 5TH FLOOR, PROVIDENCE, RI, 02903, US

(73) Assignee: ITEM SOURCE LLC, PROVIDENCE, RI (US)

(21) Appl. No.: 11/776,139

(22) Filed: Jul. 11, 2007

Related U.S. Application Data
(60) Provisional application No. 60/806,952, filed on Jul. 11, 2006.

(51) Int. Cl. B26F 3/00

(52) U.S. Cl. 225/103; 206/528; 30/124

(57) ABSTRACT

The present invention provides a pill splitter designed for cutting pills in a relatively safe manner. The pill splitter includes a main body with a top housing and a bottom housing having a blade mounted thereto. The top housing has a slot defined therein for receipt of the blade. The top housing moves relative to the bottom housing. A lid is hingedly connected to the top housing. A locking mechanism is positioned on the lid for controlling the movement of the top housing relative to the bottom housing and the blade. In the protected position, when the locking mechanism is engaged, the top housing resides in front of the blade to prevent a user from contacting the blade. In the cutting position, when the locking mechanism is disengaged, the blade is routed through the slot in the top housing thereby exposing a cutting edge thereof for cutting a pill.

### CROSS-REFERENCE TO RELATED APPLICATION

This application is related to and claims priority from earlier filed provisional patent application Ser. No. 60/806,952, filed Jul. 11, 2006.

### BACKGROUND OF THE INVENTION

The present invention generally relates to pill cutters or pill splitters. More specifically, the present invention relates to a pill splitter that can cut pills or tablets into smaller portions for proper dosing of a given medication.

In the medical industry, it is well known to provide pills for the delivery of medication. However, a given pill size may be too large for a desired dosage. As a result, it has become common to split or cut pills so they are smaller in size to better match the desired dosage. For example, if a 150 mg dosage of a medication is desired and only 100 mg pills or tablets are available, there is a desire to split one pill into 50 mg pill so it can be taken with a 100 mg pill so a 150 mg amount of medication can be delivered. Also, larger pills may be cut into smaller sizes to make them easier to take.

Pill splitting or cutting is very well known in the art. A pill can be split by hand with a knife but this is very dangerous. Various pill splitting devices have been created that better control this process. For example, various prior art devices include an exposed fixed blade that is mounted to a cover that closes down onto a pill that is fixed in place on a base plate. When the cover is closed, the blade comes down onto a pill to split it. These devices can be effective, however, they are still very dangerous in that it includes an exposed blade that can injure the user.

There have been a number of attempts in the prior art to provide a safer pill splitter. For example, published application Ser. No. 10/672,239 (Pub No. 2005/0067452) teaches a pill splitter that includes a sliding blade guard that retracts when the cover is closed to expose the blade when the cover is closed. This construction is complicated and expensive to manufacture and is also difficult to use.

In view of the foregoing, there is a desire to provide a pill splitter that is easy and inexpensive to manufacture yet is effective in protecting the blade when the cover is open. There is a desire for a pill splitter that more effectively and safely splits pills than prior art devices.

### SUMMARY OF THE INVENTION

An embodiment of the present invention preserves the advantages of prior pill splitters. In addition, it provides new advantages not found in currently available pill splitters and overcomes many disadvantages of such currently available pill splitters.

Generally, the present invention generally is a pill splitter used for splitting items, such as pills, into smaller sizes or pieces. Specifically, the pill splitter consistently dissects pills in a reliable and safe manner. The pill splitter provides a user an effective mechanism for splitting a pill while reducing the risk of personal injury due to contact with any sharp objects.

Generally, the pill splitter includes a main body with a top housing and bottom housing. A blade is mounted to the bottom housing of the housing for use in splitting a pill. The top housing defines a slot for receipt of the blade when the top housing is moved relative to the bottom housing to expose the blade.

A lid is hingedly connected to the top housing. The lid provides a locking mechanism integrally formed within the lid for controlling the movement of the top housing relative to the bottom housing and the blade. The lid provides a cushioning surface, such as a cushioning pad, to help secure the pill while it is being split. Also, a pill seat is positioned on the top housing to trap the pill.

When the lid is in an open position, the blade is retracted and a pill is placed in a pill seat. When the lid is in a closed position, a cushioning surface contacts a pill within a pill seat to prevent movement therein. At the same time, the locking mechanism clears from the top housing to allow for the movement of the top housing relative to the bottom housing. Subsequently, when the top housing actuates downward, the blade is exposed for cutting of a pill. After a pill is cut, the top housing is spring-bias to return to its original position.

In one embodiment, a latch engages a loop located on the top housing to control the movement of the top housing relative to the bottom housing. When the lid is open, the latch hooks the loop to prevent the movement of the top housing relative to the bottom housing. When the lid is closed, the latch clears the loop located which allows for the movement of the top housing relative to the bottom housing.

In use, the top housing moves relative to the bottom housing between a protected position and a cutting position. In the protected position, the top housing resides in front of the blade to prevent a user from contacting the blade. In the cutting position, the blade is routed through the slot in the top housing thereby exposing a cutting edge thereof for cutting a pill.

It is therefore an object of the pill splitter to provide a reliable and safe mechanism for cutting a pill into smaller sizes.

It is a further object of the embodiment to provide the pill splitter that conceals a blade until the lid is in a closed position.

Another object of the embodiment is to provide the pill splitter that reduces the risk of personal injury to a user.

### BRIEF DESCRIPTION OF THE DRAWINGS

The novel features which are characteristic of the pill splitter are set forth in the appended claims. However, the pill splitter, together with further embodiments and attendant advantages, will be best understood by reference to the following detailed description taken in connection with the accompanying drawings in which:

FIG. 1 is a perspective view of a pill splitter of the first embodiment of the present invention;

FIG. 2 is a close-up perspective view of the pill splitter in FIG. 1 with the lid in an open position;

FIG. 3 is a top view of the pill splitter in FIG. 1 with the lid in a closed position and a pill in a pill seat prior to splitting;

FIG. 4 is a top view of the pill splitter in FIG. 1 with the lid in a closed position and the pill positioned within a pill seat during splitting;

FIG. 5 is a perspective view of the pill splitter in FIG. 1 with lid in an open position and the pill positioned within a pill seat after splitting;

FIG. 6A is a side view of the pill splitter in FIG. 1 with the lid in an open position and the locking mechanism engaged;

FIG. 6B is a side view of the pill splitter in FIG. 1 with the lid in a closed position and the locking mechanism disengaged;

FIG. 7 is a perspective view of a pill splitter of the second embodiment of the present invention;

FIG. 8 is a perspective view of the pill splitter in FIG. 7 with the lid in the closed position and a pill in the pill seat prior to splitting;

FIG. 9 is a side view of the pill splitter in FIG. 7 with the lid in a closed position and pressed downwardly for splitting of the pill;

FIG. 10 is a side view of the pill splitter in FIG. 7 with the lid in the closed position and the user moving lid relative to housing for splitting a the pill;

FIG. 11 is perspective view of the pill splitter in FIG. 7 with the lid in a closed position and the pill positioned within a pill seat after splitting;

FIG. 12 a front view of the pill splitter in FIG. 7 with lid in an open position and the pill positioned within a pill seat after splitting;

FIG. 13 is a rear perspective view of the pill splitter in FIG. 7 with lid in an open position; and

FIG. 14 is a rear perspective view of the pill splitter in FIG. 7 with the lid in a closed position.

### DETAILED DESCRIPTION OF THE PREFERRED EMBODIMENTS

The present invention solves the problems in prior art pill splitters by providing a new and unique construction for safe and effective cutting of pills. Generally, the present invention generally is a pill splitter 10 used for splitting items, such as pills, into smaller sizes or pieces. Specifically, a pill splitter 10 dissects pills in a reliable and safe manner. The pill splitter 10 provides a user an effective mechanism for splitting a pill while reducing the risk of personal injury due to contact with any sharp edges.

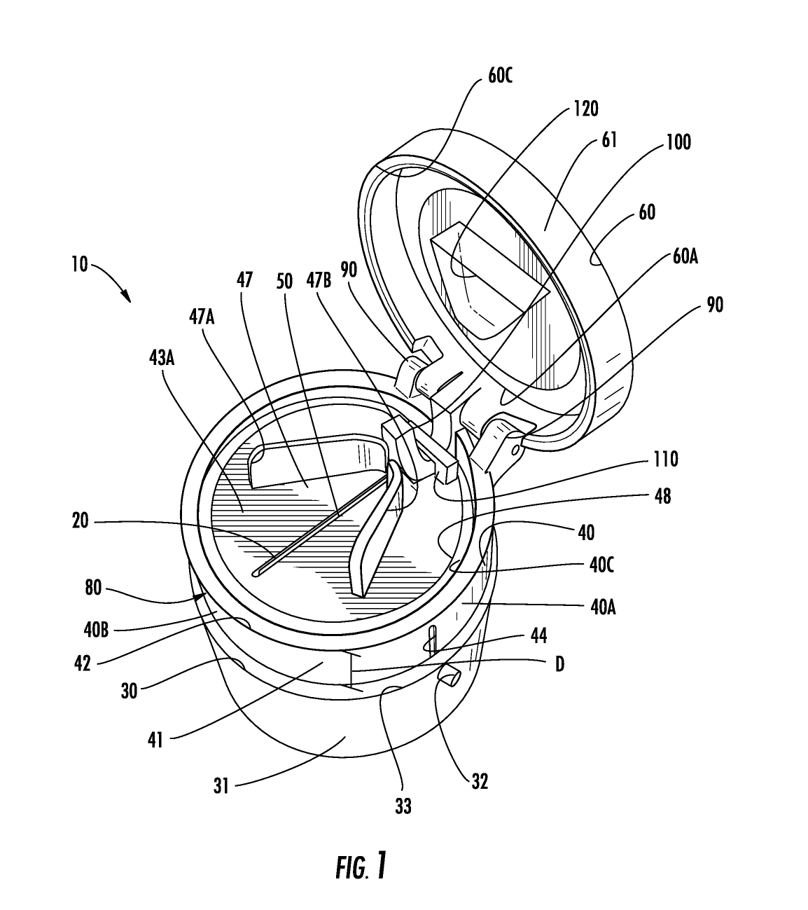

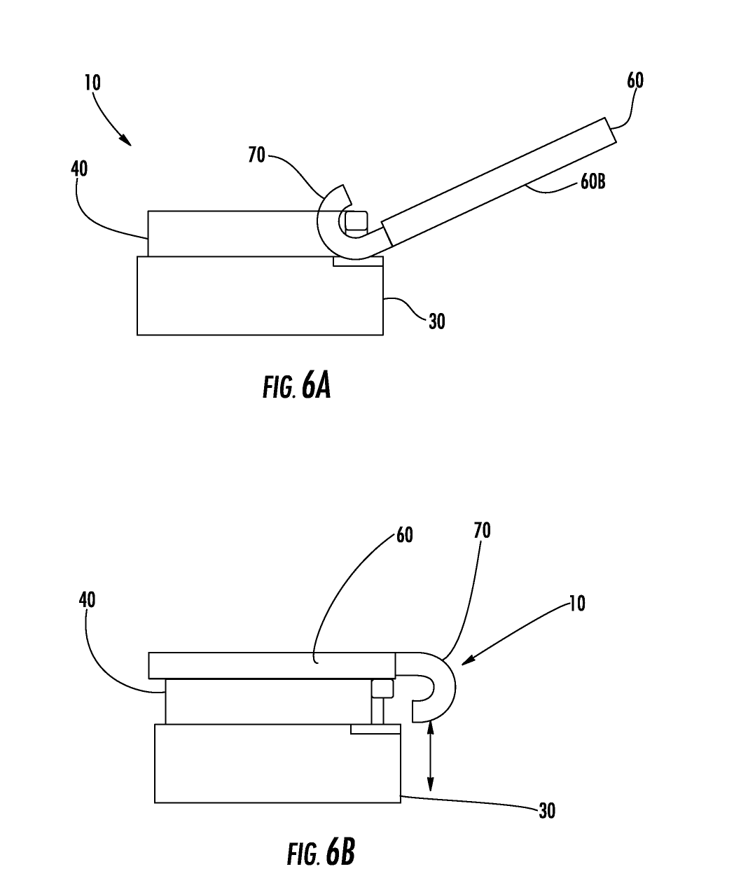

Referring now to FIGS. 1-14, the present invention is shown in detail. More specifically, a first embodiment of the pill splitter 10 is shown in FIGS. 1-6 and a second embodiment of the pill splitter 200 is shown in FIGS. 6-14. While FIGS. 1-14 illustrate two embodiments, it should be understood that the present invention can be carried out in a number of different ways and that that two embodiments shown and described herein are two examples of how the invention can be carried out.

In general, the pill splitter 10 includes a blade 20 attached to a bottom housing 30 that moves relative to a top housing 40 that includes a slot 50 defined therein. The top housing 40 and the bottom housing 30 move relative to one another so that the blade 20 travels through the slot 50 to split a pill P residing thereon. For example, the blade 20 may be fixed and the top housing 40 may be movable relative to the blade 20. When a lid 60 of the pill splitter 10 is open, a locking mechanism 70 prevents such relative movement thereby preventing the blade 20 from traveling through the slot 50 in the top housing 40. The locking mechanism 70 enables the user to insert a pill P for splitting or removing a split pill from the pill splitter without exposure to cutting/splitting blade 20 to avoid injury.

The first embodiment of the pill splitter 10 is shown in FIGS. 1-6. The pill splitter 10 includes a main body 80 with a top housing 40 and a bottom housing 30. The main body 80 preferably has a cylindrical shape to provide a surface easily manipulated within a user's hand. The materials used in construction of the main body 80 are preferably plastics. However, any material that is durable and with sufficient strength for consistent cutting the pill P is eligible for use.

The bottom housing 30 has a diameter preferably greater than the top housing 40 to facilitate movement of the top housing 40 relative to the bottom housing 30. However, the diameter of the top housing 40 may be greater than the diameter of the bottom housing 30. A side wall 31 depends from the circumference of the bottom housing 30 with a length sufficient to receive the top housing 40. The side wall 31 has sufficient thickness for withstanding pressure applied by a user to move the top housing 40 relative to the bottom housing 30.

The top housing 40 is configured to actuate upward and downward relative to the bottom housing 30. The top housing 40 has a top plate 43 dispersed along an inner surface of the upper portion 40A of the top housing 40. In a preferred embodiment, the top plate 43 extends along an inner peripheral edge 40C of a defined opening within the upper portion 40A of the top housing 40.

The top housing 40 has a side wall 41 depending from the circumference of the top housing 40 and having a length suitable for movement relative to the bottom housing 30. The side wall 41 of the top housing 40 defines a groove 44. The groove 44 engages a bar 32, preferably made of metal, which extends through at least one side wall 31 of the bottom housing 30. When the groove 44 engages the bar 32, it provides steady movement of the top housing 40 relative to the bottom housing 30. Also, the materials used within the side wall 41 of the top housing 40 may reduce friction to allow for free movement of the top housing 40 relative to the bottom housing 30.

A lid 60 is provided that hingedly connects to the upper portion 40A of the top housing 30. The lid 60 has a side wall 61 downwardly depending from the circumference thereof. Also, the lid 60 is made of a material that allows viewing of the pill P by the user during splitting.

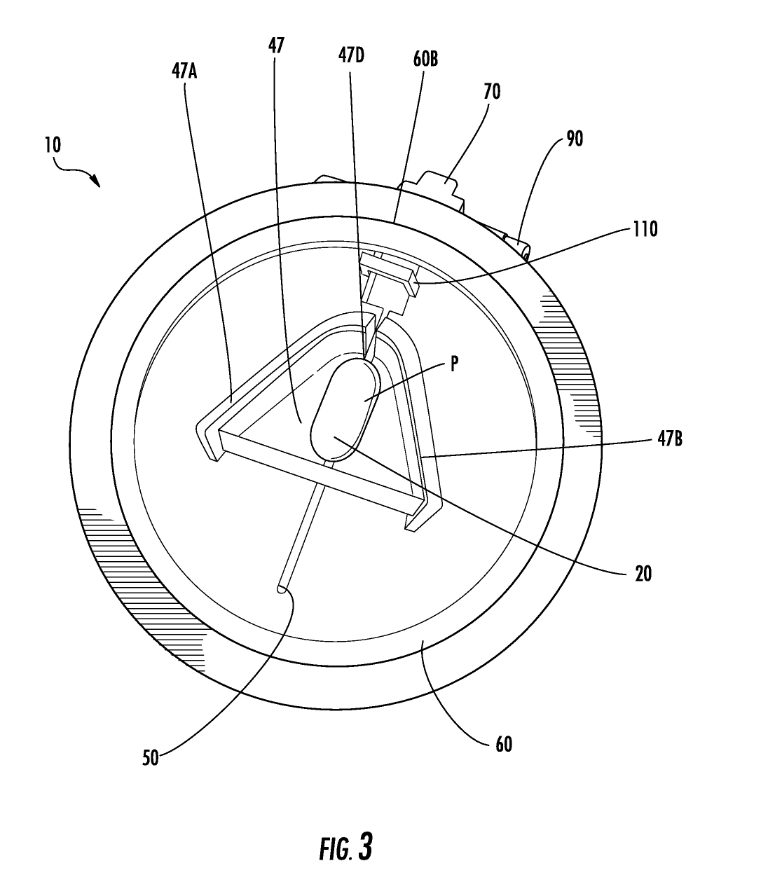

A hinge 90 respectively mounts to an upper portion 40A of the top housing 40 and the side wall 61 of the lid 60. Preferably, the hinge 90 is mounted on the upper portion 40A of the top housing 40 opposite a pill seat 47. The hinge 90 permits movement of the lid 60 from a closed position (FIG. 1) and into an open position (sees FIG. 3).

The top housing 40 further includes a top edge 42 positioned about an outer surface 40B of the top housing 40 for engagement with the bottom housing 30. Preferably, the top edge 42 is positioned along the upper portion 40A of the top housing 40 which is designed for engagement with an outer peripheral edge 33 of the bottom housing 30. The outer peripheral edge 33 of the bottom housing 30 terminates at a distance D from the top edge 42 to provide a range of movement for the top housing 40 relative to the bottom housing 30. In addition, an outer peripheral edge 60C of the lid 60 rests upon the top edge 42 when the lid 60 is in a closed position (FIG. 3) to provide stability while cutting the pill.

A locking mechanism 70 (FIG. 3) is integrally formed within the lid 60 for controlling the movement of the top housing 40 relative to the bottom housing 30. In one embodiment, the locking mechanism 70 protrudes from the outer surface 60B of the lid 60. The locking mechanism 70 is designed having a hooked shape. When the lid 60 is open, the locking mechanism 70 contacts the top housing 40 and the bottom housing 30 to prevent movement therein. The locking mechanism 70 is positioned between the top edge 42 of the top housing 40 and the outer peripheral edge 33 of the bottom housing 30. If pressure is applied to the top housing 40, when the lid 60 is open, the locking mechanism 70 prevents the movement of the top housing 40 relative to the bottom housing 30.

Additionally, a latch 100 protrudes from the inner surface 60A of the lid 60. The latch 100 is designed having a hooked shape for engagement with a loop 110 positioned on the top housing 40. The loop 110 is integrally formed within the top plate 43 of the top housing 40 which is designed to engage the latch 100 therethrough. The loop 110 is continuous with the slot 50 to allow the length of the blade 20 to travel through the top housing 40. When the lid 60 is in an open position (FIG. 1), the latch 100 engages the loop 110 to prevent the movement of the blade 20 through the slot 50. As a consequence, since the blade 20 is fixedly mounted to the bottom housing 30, the top housing 40 is prevented moving relative to the bottom housing 30 when the latch 100 engages the loop 110. When the lid 60 is in a closed position, the latch 100 disengages from the loop 110 to allow the blade 20 to travel through the slot 50.

It should also be appreciated that the latch 100/loop 110 configuration and locking mechanism 70 may be used in combination with any embodiment of the present invention to control the movement of the top housing 40 relative to the bottom housing 30 for additional safety. For example, when the lid 60 is in an open position, the latch 100 may engage the loop 110 to block the blade 20 from travelling through the slot 50 and, at the same time, the locking mechanism 70 blocks the movement of the top housing 40 relative to the bottom housing 30.

Also, the pill seat 47 is positioned along the top plate 43 and positioned about the slot 50 to provide stability to the pill P during cutting. In one embodiment, the pill seat 47 is integrally formed within the top plate 43. In another embodiment, the pill seat 47 consists of at least two walls 47A, 47B protruding from the top surface 43A of the top plate 43. The walls 47A, 47B are arranged to form a triangular shape for positioning a pill P during splitting.

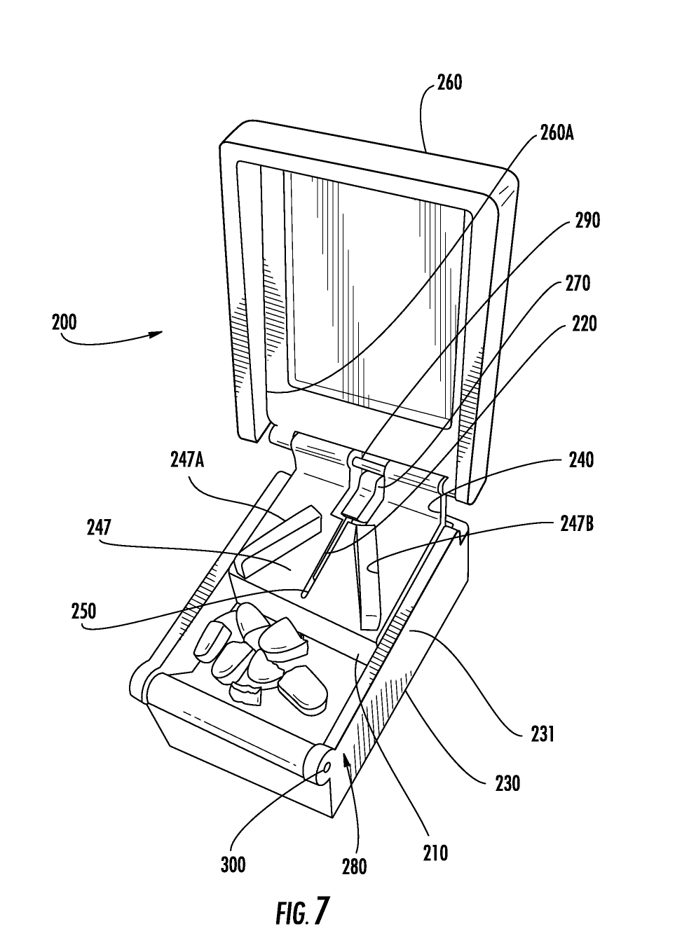

The volume of the pill seat 47 is sufficient for pills P with different shapes and sizes. Also, other items of similar size can be positioned within the pill seat 47 for cutting. When cutting multiple pills P, the outer surface 43A of the top plate 43 may be provided with an integrally formed well 210 (FIG. 7) continuous with the pill seat 47. The well 210 can be used for temporary storage of additional pills P, pill pieces, or other items.

The inner surface 60A of the lid 60 provides a downwardly protruding cushioning surface 120, such as a cushioning pad made of foam or felt. When the lid 60 is in a closed position (FIG. 3), the cushioning surface 120 occupies a volume within the pill seat 47 to trap the pill P. Other materials, such as foam, may be used in construction of the cushioning surface 120 to provide downward pressure on the pill P in the pill seat 47 during cutting. The cushioning surface 120 has a triangular shape that is sized according to an outline of the pill seat 47.

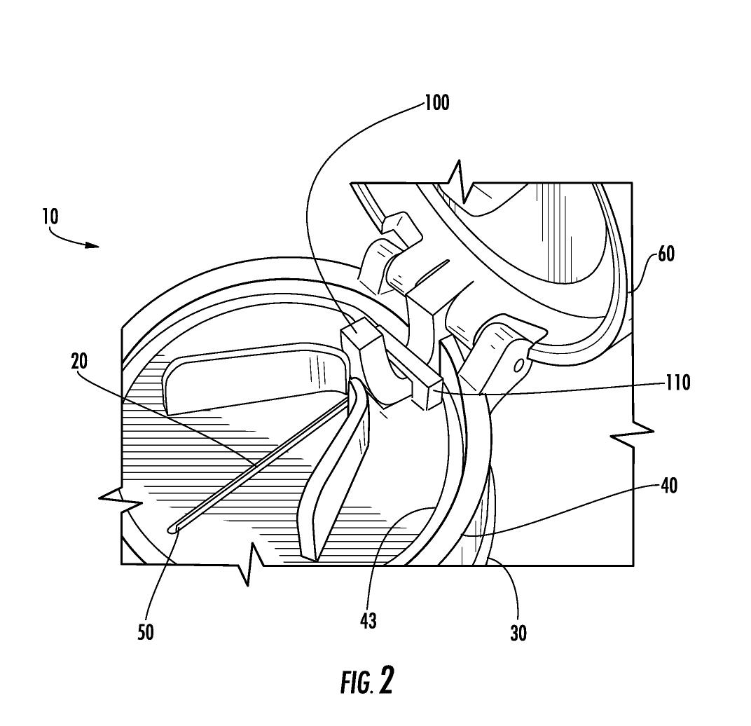

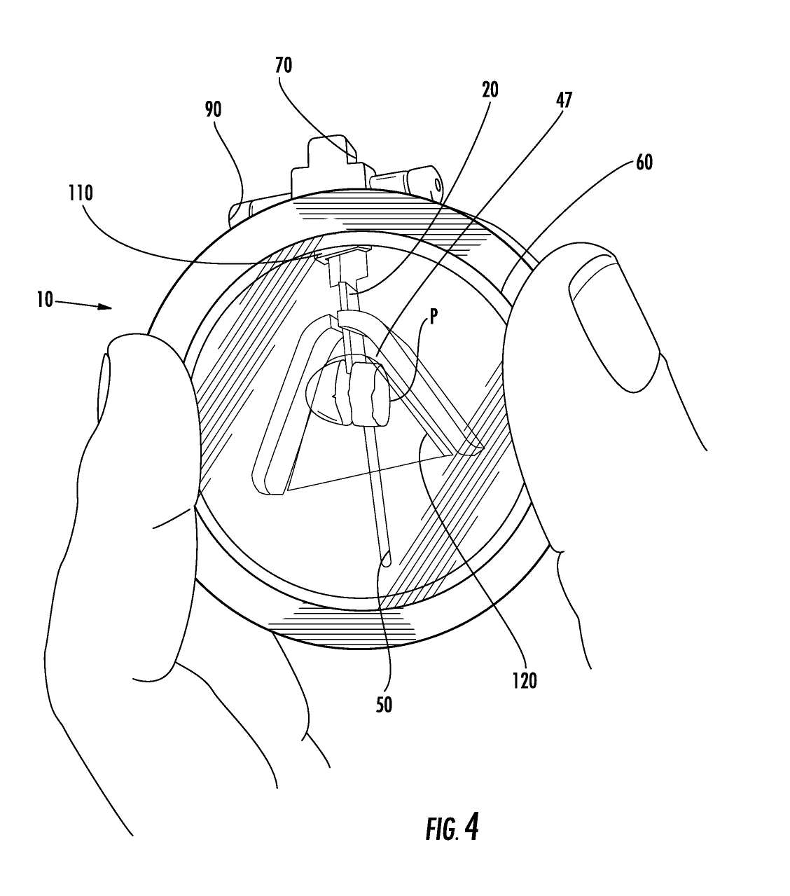

Referring to FIG. 2, a close-up view of the pill splitter 10 of FIG. 1 is shown with the lid 60 in the open position. The blade 20 is fixed to the bottom housing 30. The blade 20 has a length sufficient for cutting the pill P and occupying a portion of the loop 110. The top plate 43 defines the slot 50 for slidable movement of a blade 20 (as seen in FIG. 4) therethrough when the top housing 40 moves downwardly towards the bottom housing 30. The slot 50 is respectively positioned above the blade 20 to allow free movement of the blade 20 through the top plate 43 and into contact with the pill P.

In operation, referring now to FIG. 3, a top view of the pill splitter 10 in FIG. 1 is shown with the lid 60 in a closed position. Preferably, when the lid 60 is in an open position, a pill P is positioned within a forward portion 47D of the pill seat 47 and positioned above the slot 50 for cutting of the pill P. Of course, the pill P may be positioned anywhere above the slot 50 and within the volume of the pill seat 47.

When the lid 60 is in a closed position, the locking mechanism 70 disengages from the top housing 40 (as seen in FIG. 6B) to allow the movement of the top housing 40 relative to the bottom housing 30. By pivoting with the lid 60, the locking mechanism 70 clears the top housing 40 and the bottom housing 30. When the top housing 40 and bottom housing 30 are free to move relative to one another, it allows the travel of the blade 20 upwardly through the top housing 40.

Also, in an alternative embodiment, when the lid 60 is closed, the latch 100 and loop 110 disengage from one another. The latch 100, similar to the locking mechanism 70, pivots with the movement of the lid 60. When the lid 60 is closed, the latch 100 clears the loop 110 to allow the free movement of the top housing 40 relative to the bottom housing 30. When the latch 100 is disengaged from the loop 110, the blade 20, previously blocked when the lid 60 was in an open position, travels through the top housing 40.

Referring to FIG. 4, a top view of the pill splitter 10 of FIG. 1 is shown with the lid 60 in a closed position. The pill P is engaged by the cushioning surface 120 on the lid 60 and positioned within the pill seat 47 positioned above the slot 50. At this time, the locking mechanism 70 (as seen in FIG. 6B) is clear of the top housing 40 and bottom housing 30 to permit movement as will be described in detail below.

In FIG. 4 the user's fingers exerts downward pressure on the top housing 40 to move the top housing 40 relative to the bottom housing 30 now that the locking mechanism 70 is disengaged. For purposes of illustration, the user's fingers are depressing the lid 60 of the top housing 40.

As a result of the downward movement of the top housing 40 relative to the bottom housing 30, the blade 20 travels upwardly through the slot 50. When the blade 20 moves through the slot 50, it cuts the pill P, positioned within the pill seat 47, in an upward direction. The blade 20 cuts through the pill P until either the blade 20 is fully extended through the slot 50 or the cushioning surface 120 is contacted. The blade 20 is made of steel or other materials that provide sufficient strength to cut a plurality of pills P before replacement.

The top housing 40 is spring-biased to actuate up and down relative to the bottom housing 40. A spring (not shown) is employed between the top housing 40 and the bottom housing 30. While coil springs are preferred for this purpose, any spring-biasing members may be used.

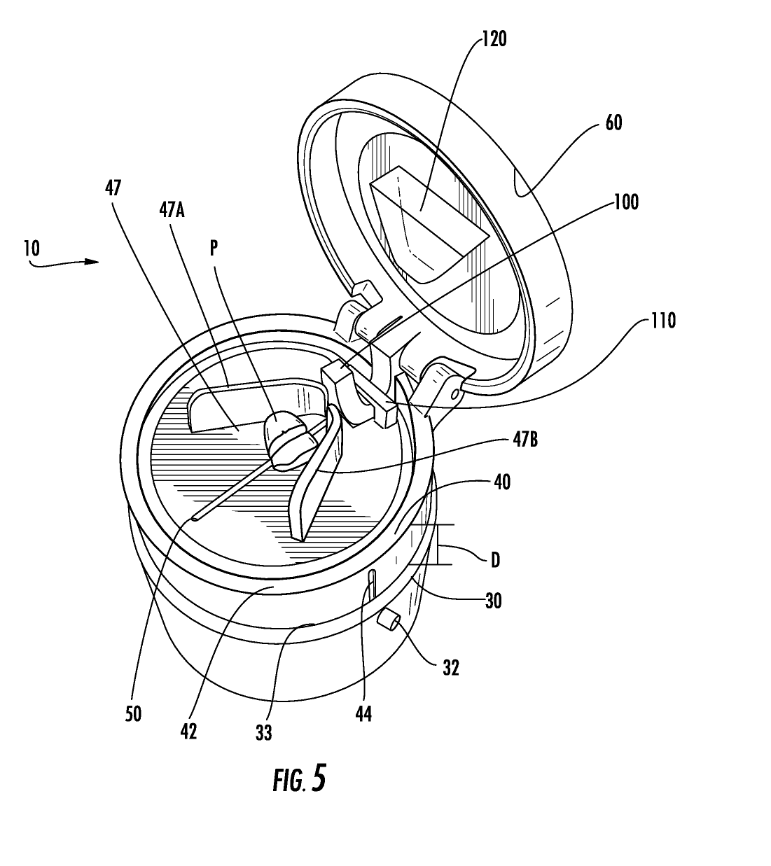

Referring to FIG. 5, a perspective view of the pill splitter 10 in FIG. 1 is shown with the lid 60 in the open position. The top housing 40 returns to its original position relative to the bottom housing 30. With the top housing 40 back in its original position, a distance D between the top edge 42 and the outer peripheral edge 33 of the bottom housing 30, the blade 20 recedes back through the slot 50. Also, when in its original position, the locking mechanism 70 prevents movement of the top housing 40 relative to bottom housing 30. The locking mechanism 70 contacts the side wall 40A of the top housing 40 to block the movement between the top housing 40 relative to the bottom housing 30. Also, in one embodiment, when the top housing 40 is in its original position, the latch 100 engages the loop 110 to block or prevent the movement of the blade 20 through the top housing 40. Now, the user can remove the pieces of the pill P from the pill seat 47.

Referring to FIG. 6A and FIG. 6B, the locking mechanism 70 is integrally formed within the outer surface 60B of the lid 60. As shown in FIG. 6A, when the lid 60 is in an open position, the locking mechanism 70 is engaged to prevent movement of the top housing 40 relative to the bottom housing 30. The locking mechanism 70 contacts the side wall 40C of the top housing 40 to prevent movement of the top housing 40 relative to the bottom housing 30. As shown in FIG. 6B, when the lid 60 is in a closed position, the locking mechanism 70 is disengaged to allow the movement of the top housing 40 relative to the bottom housing 30. When the lid 60 is in a closed position, the locking mechanism 70 clears the top housing 40 and bottom housing 30 for allowance of the free movement of the top housing 40 relative to the bottom housing 30. As a result, the blade 20 is free to travel through slot 50 to split the pill P.

Referring now to FIGS. 7-14, a pill splitter 200 of the second embodiment of the present invention is shown. Instead of being actuated vertically up and down, the bottom housing 230 is hingedly connected to the top housing 240 so it can move generally up and down. The top housing 240, however, still moves relative to the bottom housing 230 so that the blade 220 can travel upwardly therethrough for pill splitting. Referring to FIG. 7, similar to FIG. 1 of the first embodiment, the pill splitter 200 includes a main body 280 with a top housing 240 and a bottom housing 230. The top housing 240 and bottom housing 230 are designed in a rectangular shape. The bottom housing 230 is hingedly connected to the top housing 240 by a floor hinge 300 positioned opposite a locking mechanism 270. The bottom housing 230 has side walls 231 depending from the peripheral edge therein. The volume of the bottom housing 230 is sufficient to allow the movement of the top housing 240 relative to the bottom housing 230.

The top housing 240 is hingedly connected to a lid 260. The hinge 290 connected to the top housing 240 and the lid 260 allows for the movement of the lid 260 to an open position to a closed position. The locking mechanism 270 protrudes from an outer surface 260B of the lid 260. When the lid 260 is in an open position, the locking mechanism 270 is positioned between the top housing 240 and bottom housing 230 to prevent movement therein. When the locking mechanism 270 is engaged, the locking mechanism 270 is wedged between the hinge 290 of the top housing 240 and the bottom housing 230 to prevent general movement along the floor hinge 300.

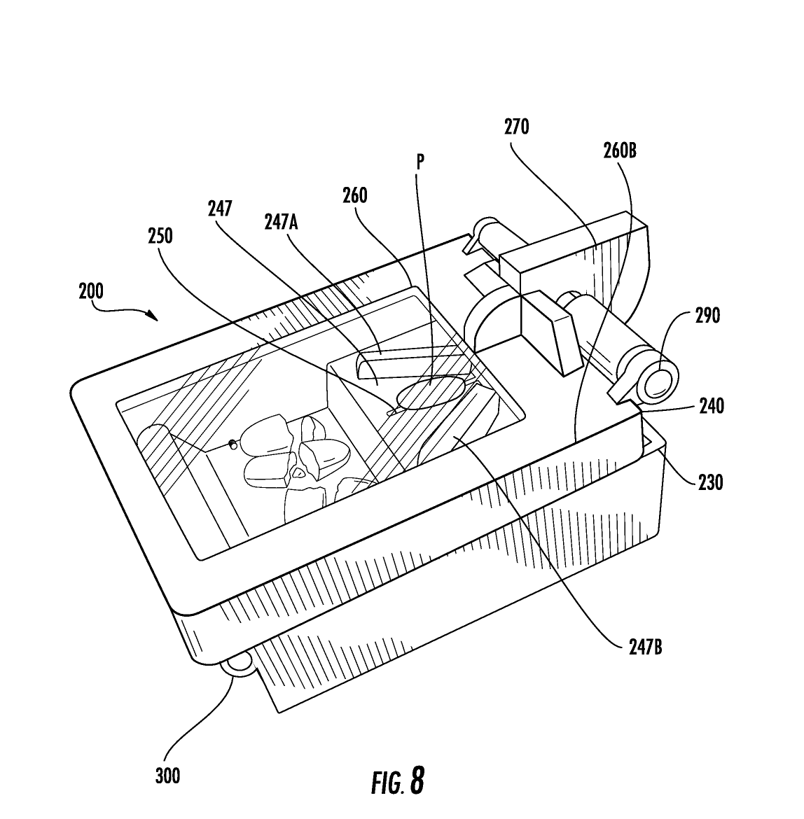

Now referring to FIG. 8, the pill splitter 200 of FIG. 7 is shown with the lid 260 in a closed position. The top housing 240 also includes an integrally formed pill seat 247, which may be cushioned. For example, the cushion 247A, 247B is made of a material such as rubber foam or other material that is durable and resilient. When the lid 260 is in a closed position, the locking mechanism 270 is disengaged. When the locking mechanism 270 is disengaged, as shown in FIGS. 8-11, the locking mechanism 270 moves clear of the top housing 240 and bottom housing 230 to allow movement relative to one another. When the top housing 240 moves relative to the bottom housing 230, the blade 220 travels through a slot 250 defined within the top housing 240.

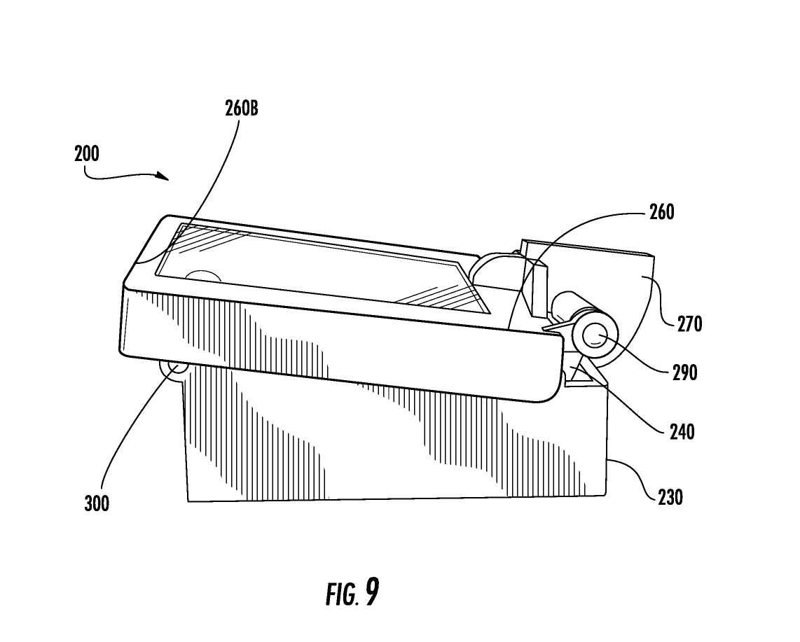

Referring now to FIG. 9, a side view of the pill splitter 200 of FIG. 7 is shown with the lid 260 in a closed position. The locking mechanism 270 is integrally formed with the outer surface 260B of the lid 260 and pivots along the hinge 290 into a disengaged position. The locking mechanism 270, when disengaged, allows the free movement of the top housing 240 relative to the bottom housing 230. Therefore, the top housing 240 pivots about the floor hinge 300 relative to the bottom housing 230 and is spring biased to an upward position.

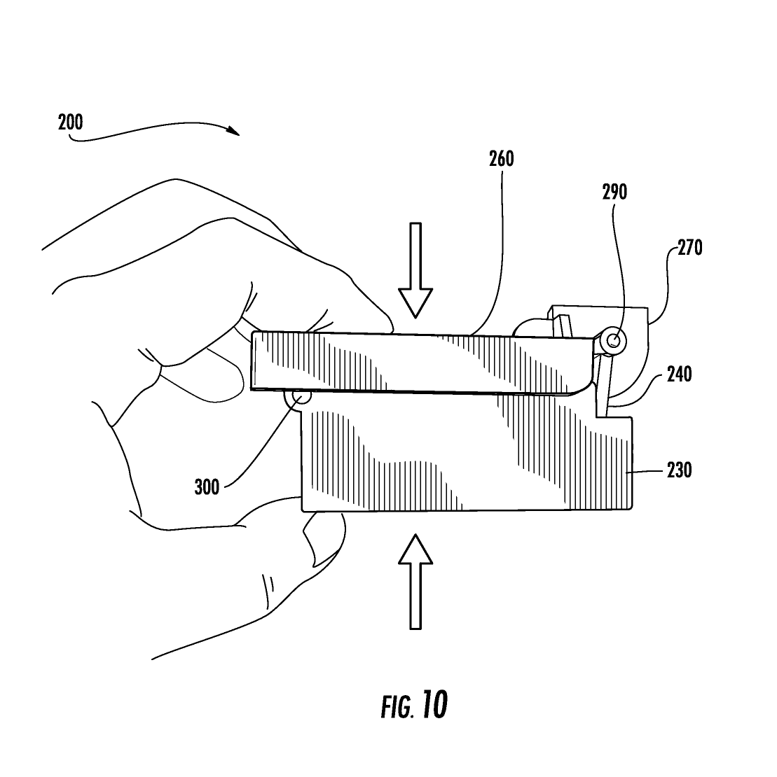

In FIG. 10 the user's fingers exerts downward pressure on the top housing 240 to move the top housing 240 relative to the bottom housing 230. For purposes of illustration, the user's hand is depressing the lid 260 hingedly connected to the top housing 240.

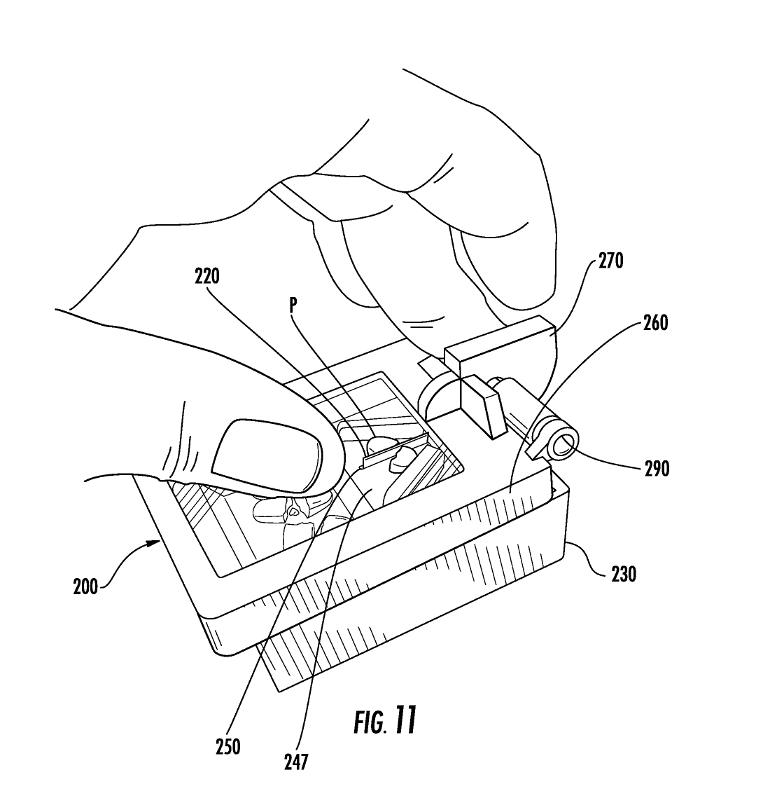

Referring to FIG. 11, the lid 260 is pressed downwardly against the biasing forces of a spring (not shown) positioned within the bottom housing 230. As the lid 260 is pressed down, the top housing 240, in turn, moves downward. As a result of the downward movement of the top housing 240 relative to the bottom housing 230, the blade 220 travels upwardly through the slot 250. When the blade 220 moves through the slot 250, it traps the pill between the lid 260 and the top housing 240 and cuts the pill P, positioned within the pill seat 247, in an upward direction. The blade 220 upwardly cuts through the pill P until either the blade 220 is fully extended through the slot 250 or it contacts the lid 260.

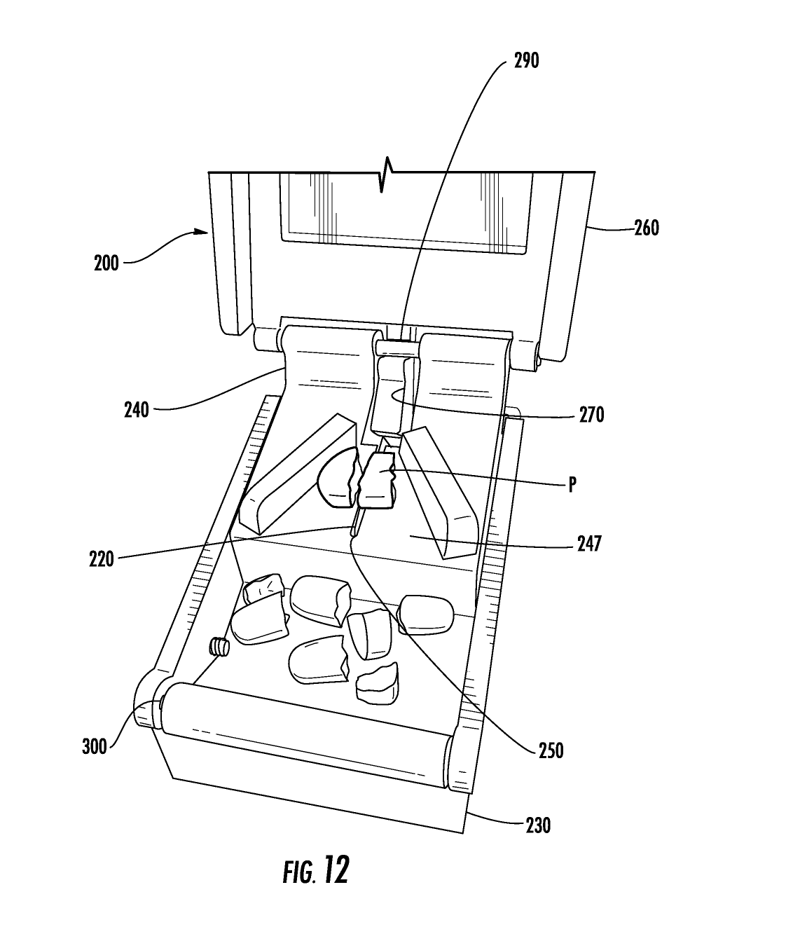

Referring to FIG. 12, the pill splitter 200 of FIG. 7 is shown with the lid 260 returned to the open position. With the top housing 240 back in its original position, the blade 220 recedes back through the slot 250. Also, when in its original position, the locking mechanism 270 is wedged between the hinge 290 of the top housing 240 and the bottom housing 230 to prevent general movement along the floor hinge 300. Now, the user can remove the pieces of the pill P from the pill seat 247.

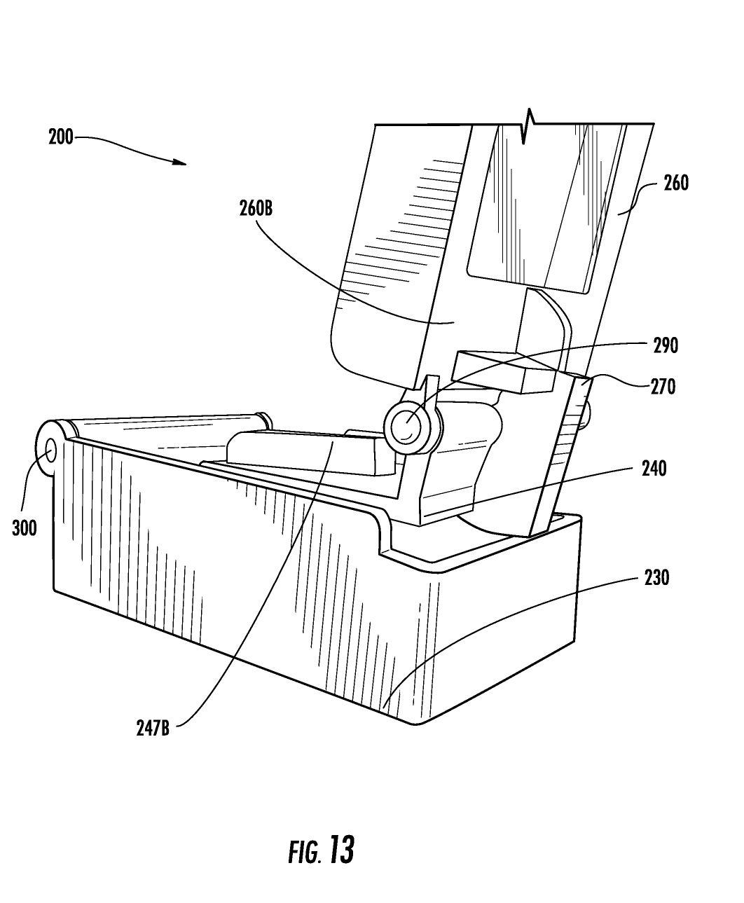

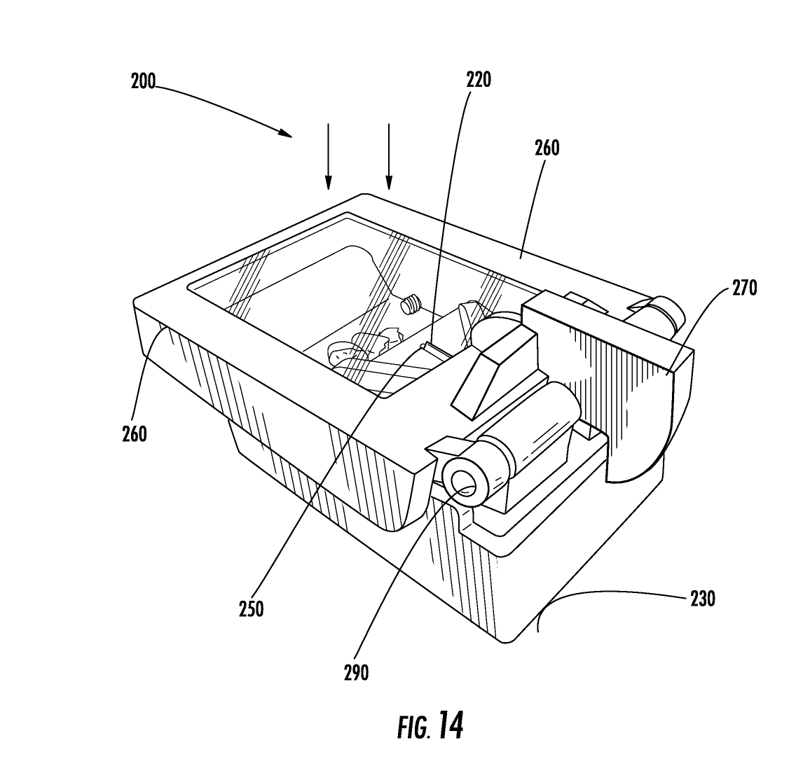

Referring to FIG. 13 and FIG. 14, the locking mechanism 270 is integrally formed within the outer surface 260B of the lid 260. As shown in FIG. 13, when the lid 260 is in an open position, the locking mechanism 270 is engaged to prevent movement of the top housing 240 relative to the bottom housing 230. As shown in FIG. 14, when the lid 260 is in a closed position, the locking mechanism 270 is disengaged to allow the movement of the top housing 240 relative to the bottom housing 230. When the lid 260 is in a closed position, the locking mechanism 270 clears the bottom housing 230 when moving downward which allows for the top housing 240 and the bottom housing 230 to actuate up and down (i.e. drop down by pivoting about the floor hinge 300). As a result, the blade 220 is free to travel through the slot 250 of the top housing 240 when the lid 260 is closed. This is an important safety feature that has a construction that is unique in the art.

In use, the top housing 40 of the pill splitter 10 moves relative to the bottom housing 30 between a protected position, blade 20 unexposed, and a cutting position, blade 20 exposed. In the protected position, the top housing 40 resides in front of the blade 20 to prevent a user from contacting the blade 20. In the cutting position, which is only possible with the lid 60 in closed position, the blade 20 is routed through the slot 50 in the top housing 40 thereby exposing a cutting edge of the blade 20 for cutting the pill P.

Therefore, the present invention provides the pill splitter 10 that is easier to operate and is safer than prior art pill splitters. The present invention includes a unique construction that has a top housing 40 that moves when the lid 60 is closed. When the lid 60 is in a closed position, the top housing 40 moves downward relative to a bottom housing 30 thereby permitting the blade 20 to protrude through the slot 50 therein to split a pill P that is trapped between the top housing 40 and the lid 60.

It would be appreciated by those skilled in the art that various changes and modifications can be made to the illustrated embodiments without departing from the spirit of the present invention. All such modifications and changes are intended to be covered by the appended claims and the present invention.

What is claimed is:

1. A pill splitter, comprising:
a main body with a top housing and a bottom housing;
a blade mounted to the bottom housing;
the top housing, having a slot therein, movable relative to the bottom housing; the blade being movable between a protected position and a cutting position; and
a lid having an inner and outer surface.

2. The pill splitter of claim 1, wherein the lid having an inner surface is hingedly connected to the top housing.

3. The pill splitter of claim 1, further comprising:
a locking mechanism positioned on the outer surface of the lid for controlling the movement of the top housing relative to the bottom housing.

4. The pill splitter of claim 1, further comprising:
a latch positioned on the inner surface of the lid designed for engagement with a loop positioned on the top housing to prevent the movement of the blade through the slot.

5. The pill splitter of claim 1, wherein the top housing is spring-biased relative to the housing.

6. The pill splitter of claim 1, wherein the lid provides a cushioning surface for cutting of a pill by the blade.

7. A pill splitter, comprising:
a main body with a top housing and a bottom housing;
a blade mounted to the bottom housing;
a means for controlling movement of the top housing relative to the bottom housing and the blade;
the top housing, having a slot therein, movable relative to the bottom housing and the blade between a protected position and a cutting position; in the protected position, the top housing residing in front of the blade preventing contact therewith and in the cutting position, when the means for preventing movement of the top housing relative to the blade is disengaged, the blade being routed through the slot in the top housing thereby exposing a cutting edge thereof for cutting a pill.

8. The pill splitter of claim 7, further comprising:
a lid with an inner and outer surface hingedly connected to the housing.

9. The pill splitter of claim 8, wherein the lid provides a cushioning surface for cutting of a pill by the blade.

10. The pill splitter of claim 7, wherein the means for controlling movement of the top housing relative to the bottom housing is a locking mechanism positioned on the outer surface of the lid.

11. The pill splitter of claim 7, further comprising:
a latch positioned on the inner surface of the lid designed for engagement with a loop positioned on the top housing to prevent the movement of the blade through the slot.

12. The pill splitter of claim 7, further comprising:
a pill seat positioned along the top housing with slot positioned therethrough.

13. The pill splitter of claim 7, wherein the top housing is spring-bias relative to the housing.

14. A pill splitter, comprising:
a main body with a top housing and a bottom housing;
a lid having an inner and outer surface hingedly attached to the top housing;
a blade mounted to the bottom housing;
a locking mechanism positioned on the outer surface of the lid to control movement of the top housing relative to the bottom housing and the blade;
the top housing, having a slot therein, movable relative to the bottom housing and the blade between a protected position and a cutting position; in the protected position, when the locking mechanism is engaged, the top housing resides in front of the blade preventing contact therewith and in the cutting position, when the locking mechanism is disengaged, the blade being routed through the slot in the top housing thereby exposing a cutting edge thereof for cutting a pill.

15. A pill splitter of claim 14, further comprising:
a lid having an inner and outer surface hingedly connected to the top housing.

16. A pill splitter of claim 15, wherein the lid provides a cushioning surface for cutting by the blade.

17. The pill splitter of claim 14, further comprising:
a pill seat positioned along the top housing with slot positioned therethrough.

18. The pill splitter of claim 14, wherein the top housing is spring-bias relative to the housing.

19. The pill splitter of claim 14, further comprising:
a latch positioned on the inner surface of the lid designed for engagement with a loop positioned on the top housing to prevent the movement of the blade through the slot.
